(19) United States
(12) Patent Application Publication
(10) Pub. No.: US 2026/0032734 A1
(43) Pub. Date: Jan. 29, 2026

(54) METHOD FOR ESTABLISHING COMMUNICATION CONNECTION AND CHIP

(71) Applicant: GUANGDONG OPPO MOBILE TELECOMMUNICATIONS CORP., LTD., Dongguan (CN)

(72) Inventor: Nande ZHAO, Dongguan (CN)

(21) Appl. No.: 19/347,916

(22) Filed: Oct. 2, 2025

Related U.S. Application Data
(63) Continuation of application No. PCT/CN2023/100695, filed on Jun. 16, 2023.

(51) Int. Cl. H04W 74/0833; H04W 72/044; H04W 72/23

(52) U.S. Cl. CPC H04W 74/0833; H04W 72/044; H04W 72/23

(57) ABSTRACT

Provided is a method for establishing a communication connection, performed by a terminal device. The method includes: establishing a communication connection with a first device group via a random access procedure, wherein the first device group includes at least one wireless access device.

### CROSS REFERENCE TO RELATED APPLICATION

This application is a continuation of International Application No. PCT/CN2023/100695, filed on Jun. 16, 2023, the entire disclosure of which is incorporated herein by reference.

### TECHNICAL FIELD

Embodiments of the present disclosure relate to the field of communications, and in particular, relate to a method for establishing a communication connection and a chip therefor.

### RELATED ART

A cell-free radio access network contains a large number of wireless access devices, which are also referred to as access points (APs). A terminal device may establish a communication connection with the wireless access devices to transmit information.

However, how to establish the communication connection between the terminal device and the wireless access devices requires further discussion and research.

### SUMMARY

Embodiments of the present disclosure provide a method and apparatus for establishing a communication connection, and a device, and a storage medium therefor.

According to some embodiments of the present disclosure, a method for establishing a communication connection is provided. The method is performed by a terminal device, and includes:
establishing a communication connection with a first device group via a random access procedure, wherein the first device group includes at least one wireless access device.

According to some embodiments of the present disclosure, a method for establishing a communication connection is provided. The method is performed by a first wireless access device in a first device group, and includes:
establishing a communication connection with a terminal device via a random access procedure, wherein the first device group includes at least one wireless access device, and the first wireless access device is any wireless access device in the first device group.

According to some embodiments of the present disclosure, a chip is provided. The chip includes programmable electric logic circuitry and/or one or more program instructions, and the chip, when running, is configured to establish a communication connection with a first device group via a random access procedure, wherein the first device group includes at least one wireless access device.

### BRIEF DESCRIPTION OF DRAWINGS

FIG. 1 is a schematic diagram of a network architecture according to some embodiments of the present disclosure;

FIG. 2 is a schematic diagram of a cell-free radio access network (RAN) according to some embodiments of the present disclosure;

FIG. 3 is a schematic flowchart of a method for establishing a communication connection according to some embodiments of the present disclosure;

FIG. 4 is a schematic diagram of a device group of a cell-free RAN according to some embodiments of the present disclosure;

FIG. 5 is a schematic diagram of a device group of an NTN network according to some embodiments of the present disclosure;

FIG. 6 is a schematic diagram of a transmission resource for first information according to some embodiments of the present disclosure;

FIG. 7 is a schematic diagram of an initial downlink BWP according to some embodiments of the present disclosure;

FIG. 8 is a schematic flowchart of a method for establishing a communication connection according to some embodiments of the present disclosure;

FIG. 9 is a schematic flowchart of a method for establishing a communication connection according to some embodiments of the present disclosure;

FIG. 10 is a schematic block diagram of an apparatus for establishing a communication connection according to some embodiments of the present disclosure;

FIG. 11 is a schematic block diagram of an apparatus for establishing a communication connection according to some embodiments of the present disclosure; and

FIG. 12 is a schematic structural diagram of a communication device according to some embodiments of the present disclosure.

### DETAILED DESCRIPTION

For clearer descriptions of the objectives, technical solutions, and advantages of the present disclosure, the embodiments of the present disclosure are described in detail hereinafter in conjunction with the companying drawings.

The network architecture and service scenarios described in the embodiments of the present disclosure are intended to illustrate the technical solutions according to the embodiments of the present disclosure more clearly but do not limit the technical solutions. Those skilled in the art understand that with the evolution of the network architecture and emergence of new service scenarios, the technical solutions according to the embodiments of the present disclosure are also applicable to addressing similar technical problems.

The technical solutions according to the embodiments of the present disclosure are applicable to various types of communication systems, for example: a global system of mobile communication (GSM), a code-division multiple access (CDMA) system, a wideband code-division multiple access (WCDMA) system, a general packet radio service (GPRS), a long-term evolution (LTE) system, an advanced long-term evolution (LTE-A) system, a new radio (NR) system, an evolved system of the NR system, an LTE-based access to unlicensed spectrum (LTE-U) system, an NR-based access to unlicensed spectrum (NR-U), a non-terrestrial networks system, a universal mobile telecommunications system (ULAN), a wireless local area network (WLAN), a wireless fidelity (Wi-Fi) network, a 5^{th} Generation system (5G), and the like communication systems.

Generally, traditional communication systems support a limited number of connections and are easy to implement. However, with the development of communication technology, mobile communication systems will not only support traditional communication, but also device-to-device (D2D) communications, machine-to-machine (M2M) communications, machine-type communications (MTC), vehicle-to-vehicle (V2V), or vehicle-to-everything (V2X) communications, and the like. The embodiments of the present disclosure are also applicable to the above communication systems.

The communication system in the embodiments of the present disclosure is applicable to a carrier aggregation (CA) scenario, a dual connectivity (DC) scenario, also to a standalone (SA) networking scenario.

The communication system in the embodiments of the present disclosure is applicable to an unlicensed spectrum, wherein the unlicensed spectrum may also be referred to as a shared spectrum; or the embodiments of the present disclosure are also applicable to a licensed spectrum, wherein the licensed spectrum may also be referred to as an unshared spectrum.

The embodiments of the present disclosure are applicable to a non-terrestrial networks (NTN) system or a terrestrial networks (TN) system.

FIG. 1 is a schematic diagram of a network architecture according to some embodiments of the present disclosure. The network architecture includes: a terminal device 10, an access network device 20, and a core network element 30.

The terminal device 10 may refer to a user equipment (UE), an access terminal, a user element, a user station, a mobile station, a mobile platform, a remote station, a remote terminal, a mobile device, a wireless communication device, a user agent or a user apparatus. In some embodiments, the terminal device 10 may also be a cellular phone, a cordless phone, a Session Initiation Protocol (SIP) phone, a wireless local loop (WLL) station, a personal digital assistant (PDA), a handheld device with a wireless communication function, a computing device or other processing devices connected to a wireless modem, a vehicle-mounted device, a wearable device, a terminal device in a 5^{th} generation system (5GS) or a terminal device in a future evolved public land mobile network (PLMN), or the like, which is not limited in the embodiments of the present disclosure. For ease of description, the above devices are collectively referred to as a terminal device. Generally, there is a plurality of terminal devices 10, and one or more terminal devices 10 may be deployed within each cell managed by the access network device 20. In the embodiments of the present disclosure, the terms “terminal device” and “UE” are often used interchangeably, but those skilled in the art should understand their meaning.

The access network device 20 is a device deployed in an access network to provide a wireless communication function for the terminal device 10. The access network 20 may include various forms of macro base stations, micro base stations, relay stations, APs, or the like. In a system using different wireless access technologies, the name of a device with the function of an access network device may be different. In the 5G NR system for instance, the device with the function of the access network device is called a gNodeB or a gNB. With the evolution of communication technology, the name “access network device” may vary. For ease of description, in the embodiments of the present disclosure, the terminal device 10 providing a wireless communication function is referred to as the access network device. In some embodiments, a communication between the terminal device 10 and the core network element may be established via the access network 20. Exemplarily, in an LTE system, the access network device 20 may be an evolved universal terrestrial radio access network (EUTRAN) or one or more eNodeBs in the EUTRAN; and in a 5G NR system, the access network device may be a radio access network (RAN) or one or more gNBs in the RAN.

The core network element 30 is a network element deployed in a core network, and the main function of the core network element 30 is to provide user connectivity, user management, and service bearing, which operates as a gateway providing an interface to an external network. For example, the core network in the 5G NR system may include an access and mobility management function (AMF) entity, a user plane function (UPF) entity and a session management function (SMF) entity, and the like network element. Furthermore, the core network element may be considered as a functional entity, and one or more core network elements may be deployed onto one physical device.

In some embodiments, the access network device 20 and the core network element 30 communicate with each other via an air interface technology, such as an NG interface in the 5G NR system. The access network device 20 and the terminal device 10 communicate with each other over an air interface technology, such as a Uu interface.

The term “5G NR system” in the embodiments of the present disclosure may also be referred to as a 5G system or an NR system, and those skilled in the art should understand their meanings. The technical solutions according to the embodiments of the present disclosure are applicable to an LTE system, a 5G NR system, a future evolved system of the 5G NR system, a narrow-band Internet of things (NB-IoT) system, and the like communication systems, which is not limited by the present disclosure.

In the embodiments of the present disclosure, the access network device may provide services for a cell, while the terminal device communicates with the access network device over transmission resources (e.g., a frequency-domain resources, or frequency spectrum resources) on carriers used by the cell. The cell may be a cell corresponding to the access network device (e.g., a base station), a macro base station, or a small cell. The small cell may include: a metro cell, a micro cell, a pico cell, a femto cell, or the like. These small cells have the characteristics of small coverage and low transmission power, which are applicable to providing high-speed information transmission services.

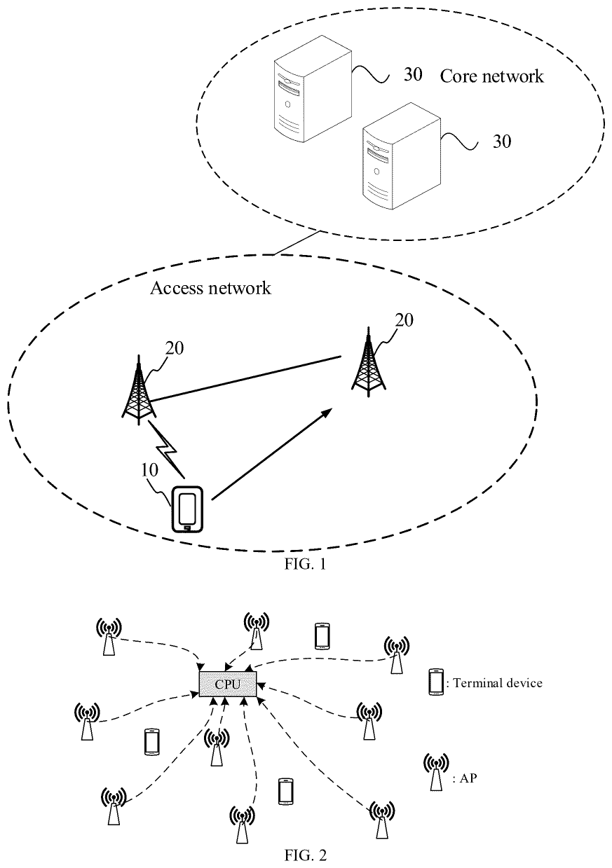

With the evolution of technologies, the concept of a cell-free RAN has been proposed. As illustrated in FIG. 2, the cell-free RAN may refer to a network established by a large number of distributed, low cost, and low power consumption APs. The APs may perform simple physical layer functions such as transmission and reception of wireless signals, channel estimation, downlink precoding, uplink signal detection, and the like. Furthermore, all APs are connected to one or more central processing units (CPUs) over a backhaul link, wherein the CPUs may perform complex physical layer functions such as AP information distribution and merging, signal modulation and demodulation, information bit encoding, and the like. In this way, all APs may simultaneously provide services to each user. As the number of APs increases, the impact of a cell boundary is eliminated, thereby creating the concept of “cell-free,” and significantly improving a system capacity and a spectrum efficiency.

Considering the limitations of signal overhead and computational complexity, it is impossible that each terminal device is simultaneously served by all APs. However, a better network scalability may be achieved by having the terminal devices only served by a subset of APs with better channel conditions, for example, only associating the terminal device with APs in its proximity. At present, how to establish an association between the terminal device and the AP is an urgent problem to be addressed.

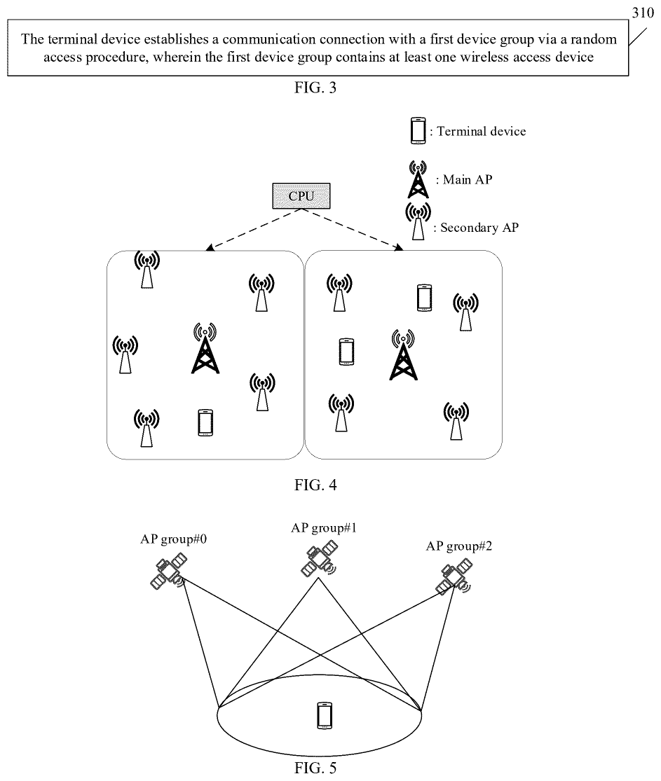

FIG. 3 is a schematic flowchart of a method for establishing a communication connection according to some embodiments of the present disclosure. The method is applicable to the network architecture illustrated in FIG. 1, and includes the following step 310.

In step 310, a terminal device establishes a communication connection with a first device group via a random access procedure, wherein the first device group includes at least one wireless access device.

Accordingly, a first wireless access device in the first device group establishes a communication connection with the terminal device via the random access procedure.

The wireless access device refers to a device with a simple physical layer function. For example, the wireless access device has at least one of the following physical layer functions: transmission and reception of wireless signals, channel estimation, downlink precoding, uplink detection, and the like.

In some embodiments, the wireless access device may be an access network device (or a base station), or a network node in the access network device, which is not limited in the present disclosure. Exemplarily, the wireless access device is the access network device, and the device group is an access network device group including at least one network access device, or is also referred to as an access network cluster. Exemplarily, the wireless access device is a network node in a network device, and the first device group is a network node group including at least one network node. The network node refers to a functional module that is capable of transmitting, receiving, or forwarding information over a communication channel.

In some embodiments, in a case where the wireless access device is a network node, the wireless access devices in a device group may be network nodes under a network device, or network nodes under a plurality of network devices, wherein the plurality of network devices are communicatively connected to each other.

In some embodiments, the wireless access device may be deployed in a terrestrial communication network or a non-terrestrial network (NTN) network.

In some embodiments, the wireless access device may also be referred to as an AP or another name, which is not limited in the present disclosure. The AP may access the network via wireless access.

In some embodiments, the method is applicable to a cell-free RAN, wherein one device group is allowed to include a plurality of wireless access devices, i.e., one device group may include one wireless access device, or a plurality of wireless access devices. However, it does not mean that each device group definitely includes a plurality of wireless access devices. The terminal device selects a first device group from the plurality of wireless access device groups, and establishes a communication connection with the first device group. Exemplarily, the cell-free RAN includes two AP groups, wherein each AP group is collectively connected to a same CPU. One AP group corresponds to one device group, and one AP group corresponds to one wireless access device.

In some embodiments, the method is applicable to the NTN network, wherein one or more satellites (a plurality of satellites are referred to as a satellite cluster, or an AP group) form one device group. The terminal device selects the first device group from the plurality of device groups, and establishes a communication connection with the first device group. Exemplarily, as illustrated in FIG. 5, the NTN network includes three AP groups (or satellite clusters or satellite groups), wherein one AP group corresponds to one device group, one AP (or satellite) corresponds to one wireless access device.

In some embodiments, wireless access devices included in the plurality of device groups are separately connected to the same processing unit or different interconnected processing units. The processing unit refers to a network device with complex physical layer functions. The complex physical layer functions include at least one of: information distribution and merging, signal modulation and demodulation, and information bit encoding and decoding for the wireless access device

Exemplarily, the wireless access devices included in the plurality of device groups are separately connected to the same processing unit.

Exemplarily, the wireless access devices included in the plurality of device groups are separately connected to different processing units, wherein the processing units are connected to each other.

In some embodiments, the above interconnectivity may refer to performing communication via a wired connection manner, or via a wireless connection manner, which is not limited in the present disclosure.

In some embodiments, the method is further applicable to a distributed network, wherein the distributed network includes a plurality of wireless access devices.

In some embodiments, the device group may be defined according to physical locations of the wireless access devices, and the wireless access devices within the same physical area are organized into one device group. Definition of a physical area is not limited in the present disclosure. For example, the physical area may be defined according to an administrative area, or according to capabilities of the wireless access device. The capabilities of the wireless access device refer to transmission and reception capabilities of the wireless access device.

The random access procedure refers to a procedure in which a communication connection is established between the terminal device and the network device.

In some embodiments, the communication connection established between the terminal and the first device group may be a communication connection established between the terminal device and all wireless access devices included in the first device group, or may be a communication connection established between the terminal device and the first wireless access device in the first device group, which is not limited in the present disclosure. The first wireless access device may be any wireless access device in the first device group, or may be a primary wireless access device in the first device group, which is not limited in the present disclosure.

In some embodiments, the primary wireless access device is predetermined. For example, the primary access device may be defined by the network, or may be predefined.

In some embodiments, the primary wireless access device may be determined by voting by the devices in the device group.

In some embodiments, prior to step 310, the method further includes step 320 and step 330.

In step 320, first information is separately received from a plurality of device groups, wherein different device groups transmit the first information over different resources.

In step 330, the first device group is determined from the plurality of device groups.

The first information may be any piece of information transmitted by the device group, and the first information indicates presence of the device group transmitting the first information.

By receiving the first information from some device group, the terminal device is capable of sensing the presence of the device group. For example, the terminal device receives the first information separately transmitted by three device groups, the terminal device is capable of sensing the presence of the three device groups. Subsequently, the terminal device may select a device group in the three device groups as the first device group.

In some embodiments, the first information includes a synchronization signal/physical broadcast channel (SSB) block.

In some embodiments, the first information is transmitted by the primary wireless access device.

In some embodiments, all wireless access devices in the device group transmit the first information.

In some embodiments, in a case where the primary wireless access device is absent in the device group, the first information may be transmitted by any wireless access device in the device group, or by part or all of the wireless access devices.

In some embodiments, the different resources include at least one type of: different time-domain resources, different frequency-domain resources, or different code-domain resources.

The term “different” denotes that the 2 resources are not exactly the same. For example, two different time-domain resources indicate that the two time-domain resources are not completely overlapped. In other words, in a case where two time-domain resources are partially overlapped, and in a case where two time-domain resources are not overlapped at all, both belong to a case where two time-domain resources are different. The same is true for frequency-domain resources and code-domain resources.

In a case where the two resources are completely different, i.e., a case where the two resources are not overlapped at all, the two resources are orthogonal. The above resources may be any of the time-domain resources, the frequency-domain resources, or the code-domain resources.

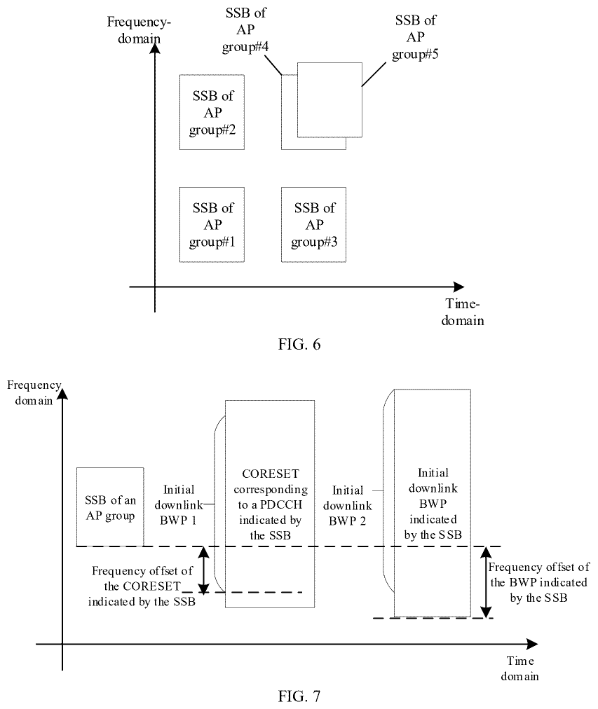

In some embodiments, different device groups transmit the first information over different frequency-domain resources such that the terminal device may distinguish different device groups based on the frequency domain position of the first information. Exemplarily, as illustrated in FIG. 6, AP group#1 and AP group#2 transmit the first information over different frequency-domain resources. For example, AP group#1 and AP group#2 transmit the SSB over RBs#20-39 and RBs#50-69, respectively, such that the terminal device simultaneously receives the SSB from the two AP groups, and distinguishes the two AP groups based on the frequency domain position.

In some embodiments, different device groups transmit the first information over different time-domain resources such that the terminal may distinguish different device groups based on a time-domain position of the first information. Exemplarily, AP group#1 and AP group#3 transmit the first information over different time-domain resources. For example, separately transmit AP group#1 and AP group#3 transmit the SSB over symbols#2-5 and symbols#8-11 of slot #0, respectively, such that the terminal device simultaneously receives the SSB from the two AP groups, and distinguishes the two AP groups at different time instants.

In some embodiments, different device groups transmit a synchronization signal in the first information over different code-domain resources such that following detection of the synchronization signal, the terminal device may distinguish the different device groups according to a codeword of the synchronization signal. For example, the synchronization signal in the first information is transmitted using a pseudo-random sequence, such as an m-sequence with good autocorrelation and cross-correlation features, and the pseudo-random sequences used by the different device groups have different sequence indexes. At this time, even in a case where the different device groups transmit the first information over the same time-domain resource, the terminal may still distinguish the different device groups according to a detection result of the synchronization signal. The detection result is the sequence index of the pseudo-random sequence corresponding to each device group.

It should be noted that the first information transmitted by the different device group needs to be different in at least one dimension of: time domain, frequency domain, or code domain. Exemplarily, as illustrated in FIG. 6, a resource occupied by AP group#4 for transmitting the first information (or the synchronization signal of the SSB) is orthogonal in the code domain to a resource occupied by AP group#5 for transmitting the synchronization signal of the SSB, is orthogonal in the time domain to a resource occupied by AP group#1 for transmitting the first information, is orthogonal in the frequency domain to a resource occupied by AP group#3 for transmitting the first information, and is orthogonal in both the time domain and the frequency domain to a resource occupied by AP group#1 for transmitting the first information. In this way, the method above provides sufficient flexibility to each device group to transmit the first information.

In some embodiments, the first information includes at least one of:
indication information of the device group transmitting the first information;
a position in the time-domain resource for transmitting the first information;
transmission configuration information for a physical downlink control channel (PDCCH), wherein the PDCCH is used to schedule a transmission of a physical downlink shared channel (PDSCH);
a position in the frequency-domain resource occupied by an initial downlink bandwidth part (BWP); or
a size of the frequency-domain resource occupied by the initial downlink BWP.

The indication information of the device group refers to information uniquely indicating the device group, such as the index of the device group.

In some embodiments, the indication information of the device group includes at least one of: the index of the device group or the index of the primary wireless access device in the device group.

The index of a device group uniquely indicates the device group, and different device groups have different indexes. The index of a primary wireless access device of the device group uniquely indicates the primary wireless access device, and the primary wireless access devices in the different device groups have different sequence indexes. In some cases, the primary wireless access device in a device group is determined, and the index of the primary wireless access device may also uniquely indicate the device group.

In some embodiments, the device group includes a plurality of wireless access devices, wherein the plurality of wireless access devices include one primary wireless access device and one or more secondary wireless access devices. The primary wireless access device may be a wireless access device with more powerful functions in the plurality of wireless access devices.

In some embodiments, in a case where the device group include only one wireless access device, the wireless access device is the primary wireless access device of the device group.

In some embodiments, the indication information may be carried by information bits in the first information, or by a sequence index of the synchronization signal in the first information, which is not limited in the present disclosure.

The information bits refer to the bits used to carry information, and the sequence index refers to the sequence index of the pseudo-random sequence in the synchronization signal, wherein each pseudo-random sequence has its own serial number, known as the sequence index.

In some embodiments, the phrase “carried by information bits” indicates that the information bits include the first information.

In some embodiments, the terminal device may determine the first information based on the sequence index of the synchronization signal. In some embodiments, the sequence index of the synchronization signal is the first information.

In some embodiments, the first information may indicate the position of a time-frequency resource occupied for transmitting the first information, such that the terminal device determines the position of a time-frequency resource occupied for receiving the first information at a current instant.

In some embodiments, the first information may indicate a position in the frequency-domain resource occupied by the first information by indicating the frequency-domain resource relative to a frequency offset value in the frequency domain occupied by an initial downlink BWP. For example, the information bits in the first information indicate the frequency offset of the initial downlink BWP corresponding to the current first information. In a case where AP group#0 and AP group#1 transmit the first information on RBs#0-19 and RBs#50-69, respectively, the frequency offset value are 0 RB and 50 RBs (resource blocks), respectively.

In some embodiments, the first information may indicate a position in the time domain occupied by the first information by indicating an offset value relative to a frame boundary of the time-domain resource occupied by the first information. For example, the information bits in the first information indicate the offset value of the current first information relative to the frame boundary. In a case where AP group#0 and AP group#1 transmit the first information on symbols#2-5 and symbols#8-11 of slot#0, respectively, the offset values relative to the frame boundary are two symbols and eight symbols, respectively.

In some embodiments, the terminal device may select a device group with best signal quality of the first information from a plurality of device groups as the first device group. The present disclosure does not limit a method for measuring signal quality of the first information. Exemplarily, the signal quality of the first information may be measured based on a reference signal received quality (RSRQ), a reference signal received power (RSRP), a signal-to-interference plus noise ratio (SINR), and the like of the first information.

In some embodiments, the terminal device may select a device group closer to the terminal device as the first device group. A distance between the terminal device and some device group may refer to the distance between the terminal device and the primary wireless access device of the device group, or to a mean value of the distance between the terminal device and each wireless access device in the device group, which is not limited in the present disclosure.

The technical solutions provided by the embodiments of the present disclosure provide a solution for establishing a communication connection between the terminal device and the device group. The terminal device may establish a communication connection with one device group from a plurality of device groups via a random access procedure. As a result, the terminal device no longer needs to be served by all wireless access devices simultaneously, thereby reducing signaling overhead and computational complexity. By communicating with only one device group, the terminal device may achieve better network scalability.

Furthermore, by using different time-domain, frequency-domain, and code-domain resources to transmit the first information, the different device groups may ensure that the terminal device is capable of distinguishing the different device groups via the first information. In this way, the terminal device may determine the first device group from a plurality of device groups, and establish a communication connection with the first device group.

Upon receiving the first information transmitted by the first device group, the terminal device is required to further receive configuration information for the random access procedure, so as to establish a communication connection with the first device group via the random access procedure. The configuration information is transmitted via a PDSCH, and is scheduled via a PDCCH within a frequency range of the initial downlink BWP.

In some embodiments, the terminal device first receives the PDCCH scheduling the PDSCH carrying the configuration information. In some embodiments, transmission configuration information for the PDCCH is carried by the first information.

In some embodiments, the transmission configuration information for the PDCCH includes at least one of:
a size of the frequency-domain resource occupied by the PDCCH;
a size of the time-domain resource occupied by the PDCCH;
a position of the frequency-domain resource occupied by the PDCCH; or
a position of the time-domain resource occupied by the PDCCH.

In some embodiments, the transmission configuration information of the PDCCH may also be referred to as the transmission configuration information of control resource set (CORESET) and search space set corresponding to the PDCCH. The transmission configuration information of the CORESET and search space set corresponding to the PDCCH include at least one of:
a size of the frequency-domain resource occupied by the CORESET corresponding to the PDCCH;
a size of the time-domain resource occupied by the CORESET corresponding to the PDCCH;
a position of the frequency-domain resource occupied by the CORESET corresponding to the PDCCH; or
a position of the time-domain resource occupied by the CORESET corresponding to the PDCCH.

The size of the frequency-domain resource may be understood as a bandwidth, and the size of the time-domain resource may be understood as a number of symbols. The position of the frequency domain may be indicated by a frequency offset value on the PDCCH relative to the first information or relative to the initial downlink BWP. The position of the time-domain resource may be indicated by a time offset value on the PDCCH relative to the first information or relative to the frame boundary. The search space set corresponds to the position of the PDDCH in the time domain, and the terminal device may detect the designated PDCCH or DCI (downlink control information) by monitoring the search space set.

Since the PDCCH and the PDSCH are both scheduled in the initial downlink BWP during the random access procedure, the frequency range of the initial downlink BWP needs to be determined.

In some embodiments, in a case where the CORESET corresponding to the PDCCH scheduling the PDSCH carrying the configuration information is indicated and determined by the information bits of the first information, the frequency range of the CORESET may be the frequency range of the initial downlink BWP, as the initial downlink BWP 1 illustrated in FIG. 7. For example, AP group#0 transmits the first information on RB#20-39, and the information bits in the first information indicate that the CORESET corresponding to the PDCCH relative to the frequency offset value of the first information, is two RBs and occupies 24 RBs of bandwidth. The terminal device thereby determines that the frequency range of the CORESET and the initial downlink BWP is RBs#18-41.

In some embodiments, in a case where the information bits indicate the frequency offset value of the initial downlink BWP relative to the current first information, the initial downlink BWP may be determined upon the information bits in the first information further indicating the bandwidth of the initial downlink BWP, as the initial downlink BWP 2 illustrated in FIG. 7. For example, AP group#0 transmits the first information on RBs#20-39, and the information bits in the first information indicate that the CORESET corresponding to the PDCCH relative to the frequency offset value of the first information is two RBs, and the bandwidth of the initial downlink BWP is 100 RBs. The terminal device thereby determines that the frequency range of the initial downlink BWP is RBs#18-117.

By the above method, the terminal device may determine the initial downlink BWP based on the CORESET of the PDDCH, eliminating the need to further specify the frequency range of the initial downlink BWP. The frequency range of the initial downlink BWP may also be specified in the first information, and a more flexible initial downlink BWP can be configured.

The terminal receives the PDSCH according to the PDCCH, wherein the PDSCH carries the configuration information of the device group.

In some embodiments, the configuration information includes at least one of:
an initial uplink BWP;
a random access resource; or
ephemeris information associated with the device group transmitting the PDSCH.

In some embodiments, different device groups transmit the PDSCH over the same time-frequency resource.

In some embodiments, the PDSCH carries the configuration information required for the random access procedures associated with a plurality of device groups.

In a case where the different device groups transmitting the PDSCH uses the same time-frequency resource, the PDSCH needs to carry the configuration information required for the random access procedures associated with all the device groups such as {AP group#0, configuration information #0}, {AP group#1, configuration information #1}, or the like. The terminal selects one device group as a first device group based on previous reception results of the first information from different device groups, and initiates the random access procedure based on the configuration information associated with the first device group. The first device group (or the first wireless access device in the first device group) determines whether to establish a communication connection with the terminal device based on the configuration information in the random access procedure used by the terminal device.

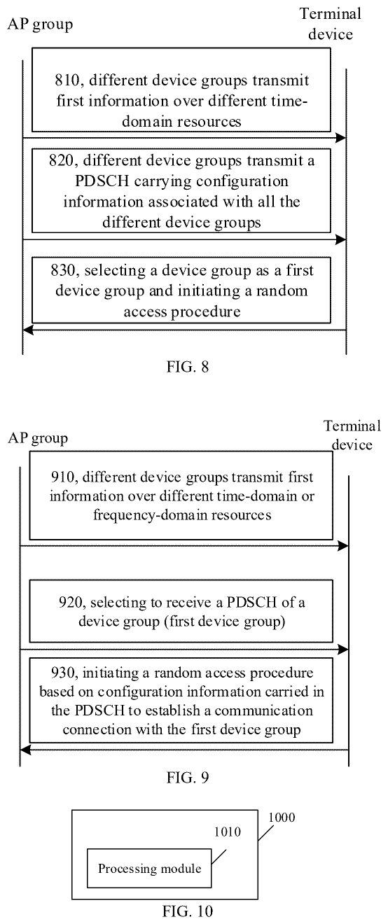

Exemplarily, as illustrated in FIG. 8, the different device groups transmit (810) the first information on different time domain or frequency-domain resources. The different device groups transmit (820) the PDSCH carrying configuration information associated with all the device group over the same time-domain resource. The terminal device selects one device group as the first device group and initiates (830) the random access procedure.

In some embodiments, the PDSCH may carry the initial uplink BWP of all the device groups such as {AP group#0, initial uplink BWP#0} and {AP group#1, initial uplink BWP#1}. Prior to receiving the first information from different device groups, the terminal device detected that the receive power of the first information of AP group#0 is larger, resulting in the terminal device selecting the initial uplink BWP corresponding to AP group#0 to transmit a physical random access channel (PRACH). Upon receiving the PRACH transmitted by the terminal device, AP group#0 completes a subsequent random access procedure with the terminal device to establish a communication connection. Similarly, the PDSCH may also carry the random access resource associated with all the device groups, and description of the process will not be repeated herein.

In some embodiments, the different device groups transmit the PDSCH over different time-frequency resources.

In some embodiments, the PDSCH carries the configuration information required by the random access procedure associated with the device group transmitting the PDSCH.

In a case where the different device groups transmit the PDSCH over different time-frequency resources, the PDSCH only needs to carry the configuration information required by the random access procedure associated with its device group. The terminal selects to receive the PDSCH of one device group (the first device group) based on a reception result of the first information from previous different device groups, and initiates the random access procedure based on the configuration information carried in the PDSCH. The device group thereby determines whether to establish a communication connection with the terminal device based on whether the terminal has initiated the random access procedure based on configuration information thereof.

Exemplarily, as illustrated in FIG. 9, the different device groups transmit (910) the first information on different time domain, frequency domain, or code-domain resources, the terminal device selects to receive (920) a PDSCH of one device group (the first device group). The terminal device initiates the random access procedure based on the configuration information carried in the PDSCH, and establishes (930) a communication connection with the first device group.

For example, AP group#0 and AP group#1 transmit the PDSCH on time-frequency-domain resource #0 and time-frequency-domain resource #1, respectively, and are associated with configuration information #01 and configuration information #1, respectively, such as initial uplink BWP#0 and initial uplink BWP#1. Prior to receiving the first information from different device groups, the terminal device detected that the receive power of the first information of AP group#0 is larger, and consequently the terminal device further receives a PDSCH on the time-domain resource, acquires the configuration information #0 such as initial uplink BWP#0, and transmits the PRACH on the initial uplink BWP#0. Upon receiving the PRACH transmitted by the terminal device, AP group#0 completes a subsequent random access procedure with the terminal device to establish a communication connection. Similarly, the configuration information carried in the PDSCH may also be the random access resource associated with its device group, and description of the process is not repeated herein.

Additionally, in an NTN system, different satellite or satellite cluster may be regarded as the different device groups. Since the ephemeris information of the different satellites is different, the configuration information carried in the PDSCH is required to further include the ephemeris information. Similarly, in a case where the different device groups transmit the PDSCH over the same time-frequency resource, the PDSCH needs to carry the ephemeris information of all the device groups; and in a case where the different AP groups transmit the PDSCH over different time-frequency resources, the PDSCH only needs to carry the ephemeris information associated with its own device group. Moreover, the process in which the terminal device selects the ephemeris information is similar to the above process of selecting the configuration information, which is not repeated herein.

The ephemeris information is used to describe satellite orbital information, a parameter and its rate of change at some moment in time, or a position of a satellite and its rate of change at some moment in time.

By the above method, the different device groups may transmit the PDSCH over the same time-frequency resource, resulting in a more concentrated time-frequency-domain resource occupied by the PDSCH. The different device groups may also transmit the PDSCH over different time-frequency resources. In this case, it is sufficient that the terminal device receives the PDSCH transmitted by the first device group selected by the terminal device, thereby reducing the information that the terminal needs to receive.

Hereinafter are the apparatus embodiments of the present disclosure, which may be used to practice the method embodiments of the present disclosure. For details not disclosed in the apparatus embodiments of the present disclosure, reference may be made to the method embodiments of the present disclosure.

FIG. 10 is a schematic block diagram of an apparatus for establishing a communication connection according to some embodiments of the present disclosure. The apparatus has a function to implement the above method for establishing a communication connection, and the function may be implemented via hardware, or via hardware executing corresponding software. The apparatus may be the terminal device described above, or implemented within the terminal device. As illustrated in FIG. 10, the apparatus 1000 may include: a processing module 1010.

The processing module 1010 is configured to establish a communication connection with a first device group via a random access procedure, wherein the first device group includes at least one wireless access device.

In some embodiments, the apparatus 1000 further includes: a receiving module (not illustrated in FIG. 10), configured to receive first information separately transmitted by a plurality of device groups, wherein the different device groups transmit the first information over different resources.

The processing module 1010 is further configured to determine the first device group from the plurality of device groups.

In some embodiments, the different resources include at least one type of: different time-domain resources, different frequency-domain resources, or different code-domain resources.

In some embodiments, the first information includes at least one of:
indication information of the device group transmitting the first information;
a position of a time-frequency resource for transmitting the first information;
transmission configuration information for a PDCCH to be transmitted by the device group transmitting the first information, wherein the PDCCH is used to schedule a transmission of a PDSCH;
a position of a frequency-domain resource occupied by an initial downlink bandwidth part (BWP); or
a size of the frequency-domain resource occupied by the initial downlink BWP.

In some embodiments, the transmission configuration information of the PDCCH includes at least one of:
a size of the frequency-domain resource occupied by the PDCCH;
a size of the time-domain resource occupied by the PDCCH;
a position of the frequency-domain resource occupied by the PDCCH; or
a position of the time-domain resource occupied by the PDCCH.

In some embodiments, the different device groups transmit the PDSCH over the same time-frequency resource.

In some embodiments, the PDSCH carries configuration information required by the random access procedure associated with the plurality of device groups.

In some embodiments, the different device groups transmit the PDSCH over different time-frequency resources.

In some embodiments, the PDSCH carries the configuration information required by the random access procedure associated with the device group transmitting the PDSCH.

In some embodiments, the configuration information includes at least one of:
an initial uplink BWP;
a random access resource; or
ephemeris information associated with the device group transmitting the PDSCH.

In some embodiments, the indication information of the device group includes at least one of:
an index of the device group; or
an index of the primary wireless access device in the device group.

In some embodiments, each wireless access device included in the plurality of device groups is separately connected to a same processing element or different interconnected processing elements.

FIG. 11 is a schematic block diagram of an apparatus for establishing a communication connection method according to some embodiments of the present disclosure. The apparatus has a function to implement the above method for establishing a communication connection, and the function may be implemented via hardware, or via hardware executing corresponding software. The apparatus may be the first wireless access device described above, or implemented in the first wireless access device. As illustrated in FIG. 11, the apparatus 1100 may include: a processing module 1110.

The processing module 1110 is configured to establish a communication connection with the terminal device via a random access procedure, wherein a first device group includes at least one wireless access device, and a first wireless access device is any wireless access device in the first device group.

In some embodiments, a plurality of device groups transmits first information to the terminal device over different resources, wherein the first device group is determined from the plurality of device groups.

In some embodiments, the different resources include at least one type of: different time-domain resources, different frequency-domain resources, or different code-domain resources.

In some embodiments, the first information includes at least one of:
indication information of the device group transmitting the first information;
a position of a time-frequency resource for transmitting the first information;
transmission configuration information for a PDCCH to be transmitted by the device group transmitting the first information, wherein the PDCCH is used to schedule a transmission of a PDSCH;
a position of a frequency-domain resource occupied by an initial downlink bandwidth part (BWP); or
a size of the frequency-domain resource occupied by the initial downlink BWP.

In some embodiments, the transmission configuration information of the PDCCH includes at least one of:
a size of the frequency-domain resource occupied by the PDCCH;
a size of the time-domain resource occupied by the PDCCH;
a position of the frequency-domain resource occupied by the PDCCH; or
a position of the time-domain resource occupied by the PDCCH.

In some embodiments, the different device groups transmit the PDSCH over the same time-frequency resource.

In some embodiments, the PDSCH carries configuration information required by the random access procedure associated with the plurality of device groups.

In some embodiments, the different device groups transmit the PDSCH over different time-frequency resources.

In some embodiments, the PDSCH carries the configuration information required by the random access procedure associated with the device group transmitting the PDSCH.

In some embodiments, the configuration information includes at least one of:
an initial uplink BWP;
a random access resource; or
ephemeris information associated with the device group transmitting the PDSCH.

In some embodiments, the indication information of the device group includes at least one of:
an index of the device group; or
an index of the primary wireless access device in the device group.

In some embodiments, each wireless access device included in the plurality of device groups is separately connected to a same processing element or different interconnected processing elements.

It should be noted that the apparatus according to the above embodiments is only described by way of example in terms of the division of functional modules when implementing its functions. In practice, the functions may be allocated to be completed by different functional modules as needed. That is, the device or apparatus may be divided into different functional modules to complete part or all of the functions described above.

Regarding the apparatus described in the above embodiments, the specific details regarding each module performing operations have been given in detail in the above method embodiments of the present disclosure, which are not elaborated herein. For details not disclosed in the apparatus embodiments of the present disclosure, references may be made to the method embodiments of the present disclosure.

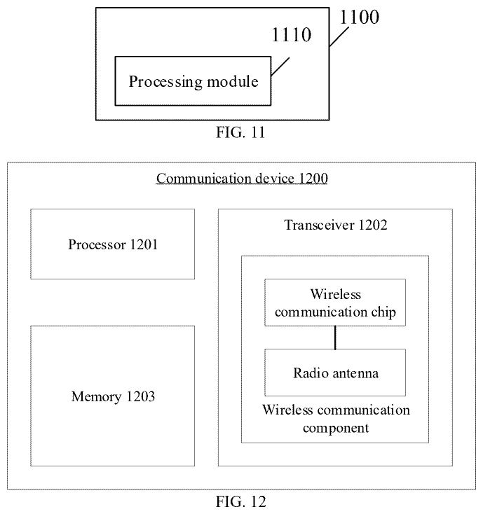

FIG. 12 is a schematic structural diagram of a communication device according to some embodiments of the present disclosure. The communication device 1200 includes: a processor 1201, a transceiver 1202, and a memory 1203.

The processor 1201 includes one or more processing cores, and executes various functional applications and information processing by running software programs and modules.

The transceiver 1202 may include a transmitter and a receiver, for example, the transmitter and the receiver may implemented as a same wireless communication component, and the wireless communication component may include a wireless communication chip and a radio frequency antenna.

The memory 1203 may be connected with the processor 1201 and the transceiver 1202.

The memory 1203 may be configured to store one or more computer programs, and the processor 1201 is configured to run the one or more computer programs to implement various procedures of the above method embodiments.

In some exemplary embodiments, in a case where the communication device is the terminal device, the processor 1201 is configured to establish a communication connection with the first device group via the random access procedure, wherein the first device group includes at least one wireless access device.

In some exemplary embodiments, in a case where the communication device is the wireless access device (such as the first wireless access device in the first device group), the processor is configured to establish a communication connection with the terminal device via the random access procedure, wherein the first wireless access device is any wireless access device in the first device group.

For details not disclosed in the apparatus embodiments of the present disclosure, references may be made to the method embodiments of the present disclosure, which will not be elaborated herein.

Furthermore, the memory may be implemented in any type of transitory or non-transitory storage device or a combination thereof, and the transitory or non-transitory storage device includes but is not limited to: a magnetic disk or optical disk, an electrical erasable programmable read-only memory (EEPROM), an erasable programmable read-only memory (EPROM), a static random-access memory (SRAM), a read-only memory (ROM), a magnetic memory, a flash memory, and a programmable read-only memory (PROM).

Some embodiments of the present disclosure further provide a computer readable storage medium storing one or more computer programs therein. The one or more computer programs when loaded and run by a processor, cause the processor to perform the method for establishing a communication connection involving the above terminal device, or the method for establishing a communication connection involving the above wireless access device. Optionally, the computer-readable storage medium includes: a ROM, a RAM, a solid state drive (SSD), an optical disk, or the like. The RAM may include a resistance random-access memory (ReRAM) and a dynamic random-access memory (DRAM).

Some embodiments of the present disclosure further provide a chip. The chip includes programmable electric logic circuitry and/or one or more computer instructions, wherein the chip, when running a processor, is configured to perform the method for establishing a communication connection method involving the above terminal device, or the method for establishing a communication method involving the above wireless access device.

Some embodiments of the present disclosure further provide a computer program product or computer program. The computer program product or computer program includes one or more computer instructions, wherein the one or more computer instructions are stored in the computer readable storage medium. The one or more computer instructions, when loaded and executed by a processor from the computer-readable storage medium, cause the processor to perform the method for establishing a communication connection involving the above terminal device, or the method for establishing a communication connection involving the above wireless access device.

It should be understood that the term “indicate” in the embodiments of the present disclosure means the direct indication, indirect indication, or an associated relationship. For example, A indicating B means that A directly indicates B, for example, B is acquired via A, A indirectly indicates B, for example, A indicates C and a B is acquired via C, A and B and associated.

In the description of the embodiments of the present disclosure, the term “corresponding” may indicate a direct or indirect correspondence between two items, or an association relationship between the two items, or a relationship between indication and being indicated, configuration and being configured, and the like.

In some embodiments of the present disclosure, the term “predefined” is implemented by pre-storing corresponding codes, tables, or other means that may be defined to indicate related message in devices (including, for example, terminal devices and network devices), and the present disclosure does not limit the specific implementation thereof. For example, the term “predefined” refers to being “defined” in a protocol.

In some embodiments of the present disclosure, the term “protocol” may indicate a standard protocol within the field of communication, for example, the term may include an LTE protocol, an NR protocol or related protocols used in future communication systems, which is not limited in the present disclosure.

The mentioned term “a plurality of” herein means two or more. The term “and/or” describes the association relationship between the associated objects, and indicates that three relationships may be present. For example, the phrase “A and/or B” means (A), (B), or (A and B). The symbol “/” generally indicates an “or” relationship between the associated objects.

Reference herein to “greater than or equal to” may indicate greater than or equal to or just greater than, and “less than or equal to” may indicate less than or equal to or just less than.

In addition, serial numbers of the processes described herein only show an exemplary possible sequence of performing the processes. In some other embodiments, the processes may also be performed out of the numbering sequence, for example, two processes with different serial numbers are performed simultaneously, or two processes with different serial numbers are performed in reverse order to the illustrated sequence, which is not limited in the present disclosure.

Those skilled in the art should understand that in one or more of the above embodiments, the functions described in the embodiments of the present disclosure may be implemented in hardware, software, firmware, or any combination thereof. The functions, when implemented in software, may be stored in a computer-readable medium or transmitted as one or more instructions or codes on a computer readable medium. The computer-readable medium includes a computer storage medium and a communication medium, where the communication medium includes any medium that facilitates the transfer of a computer program from one place to another. The storage medium is any available medium that is accessible by a general-purpose or special-purpose computer.

Described above are merely exemplary embodiments of the present disclosure and are not intended to limit the present disclosure. Any modifications, equivalent substitutions, improvements and the like, made within the spirit and principle of the present disclosure should fall within the protection scope of the present disclosure.

1. A method for establishing a communication connection, performed by a terminal device, the method comprising:
establishing a communication connection with a first device group via a random access procedure, wherein the first device group comprises at least one wireless access device.

2. The method according to claim 1, wherein prior to establishing a communication connection with the first device group via the random access procedure, the method further comprises:
receiving first information from a plurality of device groups, wherein the first information is transmitted by the plurality of device groups over different resources; and
determining the first device group from the plurality of device groups.

3. The method according to claim 2, wherein the different resources comprise at least one type of: different time-domain resources, different frequency-domain resources, or different code-domain resources.

4. The method according to claim 2, wherein the first information comprises at least one of:
indication information of the device group transmitting the first information;
a position of a time-frequency resource for transmitting the first information;
transmission configuration information for a physical downlink control channel (PDCCH) to be transmitted by the device group transmitting the first information, wherein the PDCCH is used to schedule a transmission of a physical down link shared channel (PDSCH);
a position of a frequency-domain resource occupied by an initial downlink bandwidth part (BWP); or
a size of the frequency-domain resource occupied by the initial downlink BWP.

5. The method according to claim 4, wherein the transmission configuration information for the PDCCH comprises at least one of:
a size of the frequency-domain resource occupied by the PDCCH;
a size of the time-domain resource occupied by the PDCCH;
a position of the frequency-domain resource occupied by the PDCCH; or
a position of the time-domain resource occupied by the PDCCH.

6. The method according to claim 4, wherein different device groups transmit a PDSCH over the same time-domain resource, and the PDSCH carries configuration information required by the random access procedure associated with a plurality of device groups.

7. The method according to claim 4, wherein different device groups transmit a PDSCH over different time-domain resources, and the PDSCH carries configuration information required by the random access procedure associated with the device group transmitting the PDSCH.

8. The method according to claim 7, wherein the configuration information comprises at least one of:
an initial uplink BWP;
a random access resource; or
ephemeris information associated with the device group transmitting the PDSCH.

9. The method according to claim 4, wherein indication information of the device group includes at least one of:
an index of the device group; or
an index of a primary wireless access device in the device group.

10. The method according to claim 2, wherein the wireless access device in a plurality of device groups is connected to a same processing element or different interconnected processing elements.

11. A method for establishing a communication connection, performed by a first wireless access device in a first device group, the method comprising:
establishing a communication connection with a terminal device via a random access procedure, wherein the first device group comprises at least one wireless access device, and the first wireless access device is any wireless access device in the first device group.

12. The method according to claim 11, wherein a plurality of device groups transmit first information over different resources, and the first device group is determined from the plurality of device groups.

13. The method according to claim 12, wherein the different resources comprise at least one type of: different time-domain resources, different frequency-domain resources, or different code-domain resources.

14. The method according to claim 13, wherein the first information comprises at least one of:
indication information of the device group transmitting the first information; wherein indication information of the device group comprises at least one of: an index of the device group or an index of a primary wireless access device in the device group;
a position of a time-frequency resource for transmitting the first information;
transmission configuration information for a physical downlink control channel (PDCCH) to be transmitted by the device group transmitting the first information, wherein the PDCCH is used to schedule a transmission of a physical down link shared channel (PDSCH);
a position of the frequency-domain resource occupied by an initial downlink bandwidth part (BWP); or
a size of the frequency-domain resource occupied by the initial downlink BWP.

15. The method according to claim 14, wherein the transmission configuration information for the PDCCH comprises at least one of:
a size of the frequency-domain resource occupied by the PDCCH;
a size of the time-domain resource occupied by the PDCCH;
a position of the frequency-domain resource occupied by the PDCCH; or
a position of the time-domain resource occupied by the PDCCH.

16. The method according to claim 14, wherein different device groups transmit a PDSCH over the same time-domain resource, and the PDSCH carries configuration information required by the random access procedure associated with a plurality of device groups.

17. The method according to claim 14, wherein different device groups transmit a PDSCH over different time-domain resources, and the PDSCH carries configuration information required by the random access procedure associated with the device group transmitting the PDSCH.

18. The method according to claim 17, wherein the configuration information comprises at least one of:
an initial uplink BWP;
a random access resource; or
ephemeris information associated with the device group transmitting the PDSCH.

19. The method according to claim 12, wherein wireless access device in a plurality of device groups are connected to a same processing element or different interconnected processing elements.

20. A chip, comprising:
programmable electric logic circuitry and/or one or more program instructions; wherein the chip, when running on a device, is configured to establish a communication connection with a first device group via a random access procedure, wherein the first device group comprises at least one wireless access device.
